(19) United States
(12) Patent Application Publication
(10) Pub. No.: US 2022/0114673 A1
(43) Pub. Date: Apr. 14, 2022

(54) CLAIM ANALYSIS SYSTEMS AND METHODS

(71) Applicant: Johnson & Johnson Medical PTY LTD, New South Wales (AU)

(72) Inventors: Warwick Shaw, New South Wales (AU); Rashid Mohiuddin, New South Wales (AU); Geoff Quattromani, New South Wales (AU); Aseem Shah, New South Wales (AU); Jatin Dhir, New South Wales (AU)

(21) Appl. No.: 17/298,238

(22) PCT Filed: Nov. 20, 2019
(86) PCT No.: PCT/IB2019/059968

§ 371 Date: May 28, 2021

(30) Foreign Application Priority Data
Nov. 30, 2018 (IN) 201811045218

(51) Int. Cl. G06Q 40/08

(52) U.S. Cl. CPC G06Q 40/08

(57) ABSTRACT

Described herein is a computer implemented method. The method comprises receiving, from a submitter system, a claim review request, the claim review request comprising claim data in respect of a claim and analysing the claim data to determine whether one or more defects exist in the claim. In response to determining that no defects exist in the claim data, the method further comprises communicating a claim release message to the submitter system, the claim release message causing a claim block maintained on the claim by the submitter system to be released.

### TECHNICAL FIELD

The present disclosure is directed to claim analysis systems and methods.

### BACKGROUND

Many hospitals make claims for payments from funding bodies and/or Insurers for services provided in caring for a patient.

Insurance or payment claims are complex, and are often incorrect. This leads either to the claim being rejected by the insurer (wasting significant time and effort) or the claim being accepted despite being incomplete/incorrect (leading, for example, to insurance not being claimed for items/services that have been provided).

Due to the complexity of insurance or payment claims, however—particularly in the health care space—providing systems and methods capable of accurately and efficiently identifying potential defect in an insurance claim presents a challenging problem.

Reference to any prior art or background information in this specification is not an acknowledgment or suggestion that this prior art or background information forms part of the common general knowledge in any jurisdiction or that this prior art could reasonably be expected to be understood, regarded as relevant, and/or combined with other prior art by a skilled person in the art.

### SUMMARY

The appended claims may serve as a summary of the invention.

### BRIEF DESCRIPTION OF THE DRAWINGS

In the drawings:

FIG. 1 is a block diagram of a networked environment according to aspects of the present disclosure.

FIGS. 2 and 3 provide a flowchart indicating operations performed on submission of a claim to the claim review system.

FIG. 4 provides a flowchart indicating operations performed to create rules which can then be used for claim analysis.

FIG. 5 provides a flowchart indicating operations performed in analyzing claims.

FIG. 6 illustrates an example architecture of a review system.

FIG. 7 is a block diagram of a computing system with which various embodiments and/or features of the present disclosure may be implemented.

FIG. 8 provides an example email format of a claim defect notification.

FIG. 9 provides an example assessor user interface.

While the invention is amenable to various modifications and alternative forms, specific embodiments are shown by way of example in the drawings and are described in detail. It should be understood, however, that the drawings and detailed description are not intended to limit the invention to the particular form disclosed. The intention is to cover all modifications, equivalents, and alternatives falling within the spirit and scope of the present invention as defined by the appended claims.

### DETAILED DESCRIPTION

The general context of the present disclosure is the preparation and submission of insurance claims by a claim submitter to an insurer. For ease of reference, the claim submitter will simply be referred to as the claim submitter, and the insurer will be referred to as the claim receiver.

The present disclosure focuses on the health care domain, and in the particular context of patient health care claims that are prepared by a hospital and submitted to a health insurer for assessment and payment.

The present disclosure introduces a computer implemented claim review system. As described in detail below, the system automatically reviews received claims and provides feedback thereon in real time (or near real time). Based on the feedback the submission can (if necessary) be refined and optimized before actual submission of a claim to the claim receiver.

By providing such feedback, the claim review system assists claim submitters (e.g. hospitals) reduce revenue leakage, reduce inefficiencies, reduce costs and reduce waste within the hospital.

Environment Overview

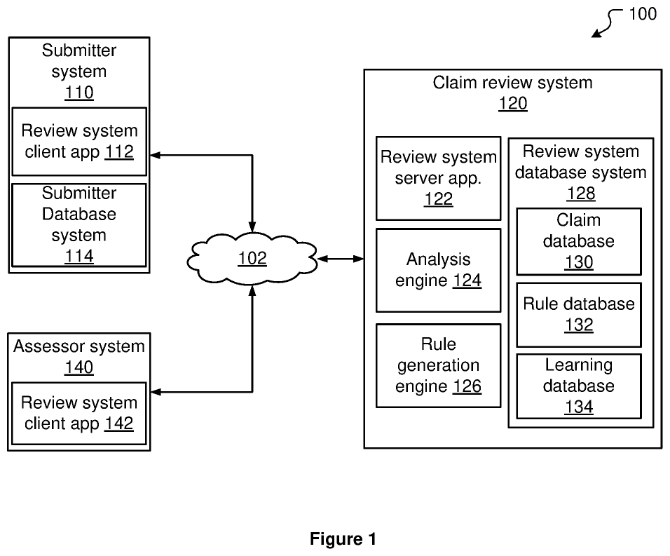

FIG. 1 illustrates an example environment 100 in which embodiments and features of the present disclosure are implemented. Example environment 100 includes a communications network 102 which interconnects a claim submitter system 110 (e.g. a hospital's system), a claim review system 120, and an assessor system 140.

Claim submitter system 110 is a computer system operated by a claim submitter. Submitter system 110 will typically include various interoperating systems running various software applications. Relevant to the present disclosure, however, system 110 includes a review system client application 112 and a submitter database system 114.

The review system client application 112 and submitter database system 114 may well be provided on separate computer systems/devices. For example, the review system client application 112 may be installed on a personal computing device (for example a laptop computer, desktop computer, mobile phone, tablet, or other computing device) and the submitter database system 114 hosted by a separate computing system (e.g. a larger hospital system). In this case the personal computing device connects to the hospital system to access the submitter database system 114—e.g. by being on the same network, a VPN connection, or other (typically secure) communication channel.

When executed by a processing unit (e.g. processing unit 702) the review system client application 112 configures the computer system that the client application is running on to provide client-side claim review system functionality. This involves communicating (using a communication interface such as 716 described below) with the claim review system 120 (and, in particular, the server application 122 provided thereby).

The review system client application 112 may take various forms. For example, it may be a dedicated application client that communicates with an API server of the claim review system 120 and submitter system database 112, a web browser (such as Chrome, Safari, Internet Explorer, Firefox, or an alternative web browser) which communicates with a claim review system web server using http/https protocols, or an add-on/integration module to an existing software application of the submitter system 110 (for example a billing system) which configures the existing software application for communication with the claim review system 120.

Submitter database system 114 stores information captured/stored by the submitter system 110 that (for present purposes) is relevant to claim submissions being prepared by the operator of the submitter system 110.

The precise data stored by the submitter database system 114 will depend on the particular context and implementation: e.g. the type of data normally captured by the submitter system 110 and the type of data expected/required by the claim review system 120. By way of example, data stored by the submitter database system 114 may include: hospital data; patient identification data; patient age data; referring doctor data; treating doctor data (and their specialties); clinical condition and/or clinical code data; clinical diagnosis and/or clinical diagnosis code data; past treatment and/or treatment code data; past, current and planned medication and dosage data; proposed treatment and/or treatment code data; actual treatment and/or treatment code data; implants used and/or implant code data; consumables used and/or consumable code data; length of surgical time data; admission date/time data; separation/discharge date/time data; length of stay data; DRG code data; clinical notes data; admission notes data; referral notes data; and or any other data.

While a single submitter system 110 has been illustrated, an environment would typically include multiple submitter systems 110 (operated by different entities) interacting with the claim review system 120. For example, each independent hospital making use of the claim review system would have its own submitter system 110.

At a high level, the claim review system 120 includes a server application 122, an analysis engine 124, a rule generation engine 126, and a database system 128.

The claim review system server application 122 configures the claim review system 120 to provide server side functionality—e.g. by receiving and responding to requests from review system client applications 112 and 114. The server application 122 may be a web server (for interacting with web browser clients) or an application server (for interacting with dedicated application clients).

The analysis engine 124 of the claim review system 120 performs claim analysis as discussed below. Generally speaking, this involves accessing or receiving claim data and analyzing it to determine whether the claim to which the data relates is acceptable or has possible defects. In certain embodiments, possible defects may be classified as either potential defects (also referred to as minor defects) or likely defects (also referred to as major defects).

The rule generation engine 126 of the claim review system 120 operates to generate the rules that the analysis engine 124 applies in the analysis of claims.

The review system database system 128 stores various information used by the claim review system 120. This includes claim data in respect of claims that have been received for analysis (in this case stored in claim database 130), rules that are generated by the rule generation engine 126 and used by the analysis engine 124 (in this case stored in rule database 132), and training data used by the rule generation engine 126 in the generation and validation of new rules (in this case stored in learning database 134).

As discussed further below, the review system 120 may be independent to the submitter system 110 (e.g. a cloud implementation providing software as a service to various submitter systems). In alternative embodiments, the review system 120 may be implemented as part of the submitter system 110—for example by installing the relevant applications and databases on hardware maintained by the submitter system 110. This can be advantageous where the submitter system (or operator thereof) does not wish to communicate claim data externally.

Environment 100 further includes an assessor system 140. Assessor system 140 is a computer processing system with a review system client application 142 installed thereon. Assessor system 140 will also have other applications installed/running thereon, for example an operating system.

When executed by the assessor system 140 (e.g. by a processing unit such as unit 702 described below), the review system client application 142 configures the assessor system 140 to provide client-side review system functionality. Review system client application 142 may be the same as client application 112 of the submitter system 110 or a different client application. As discussed further below, however, the functionality provided by client application 142 is different to that provided by client application 112. When used by a claim assessor, client application 142 configures the assessor system 140 to be used in claim assessment. When used by a rule assessor, client application 142 configures the assessor system 140 to be used in rule assessment. In contrast, client application 112 configures the submitter system 110 for use by a claim submitter. Where applications 142 and 112 are the same application, the difference is provided based on the user credentials provided to the two systems (submitter user credentials being provided to the submitter system client application 112, and claim assessor or rule assessor user credentials being provided to the reviewer system client application 112).

Communications between the various systems in environment 100 are via the communications network 102. Communications network may be a local area network, public network (e.g. the Internet), or a combination of both. Where the claim review system is maintained by the operator of the submitter system, communication between the review system client application 112 and the review system server application 122 will typically via a private network connection—e.g. a LAN of the submitter system 110 or a VPN connection.

While environment 100 has been provided as an example, alternative system environments/architectures are possible.

Claim Submission Process

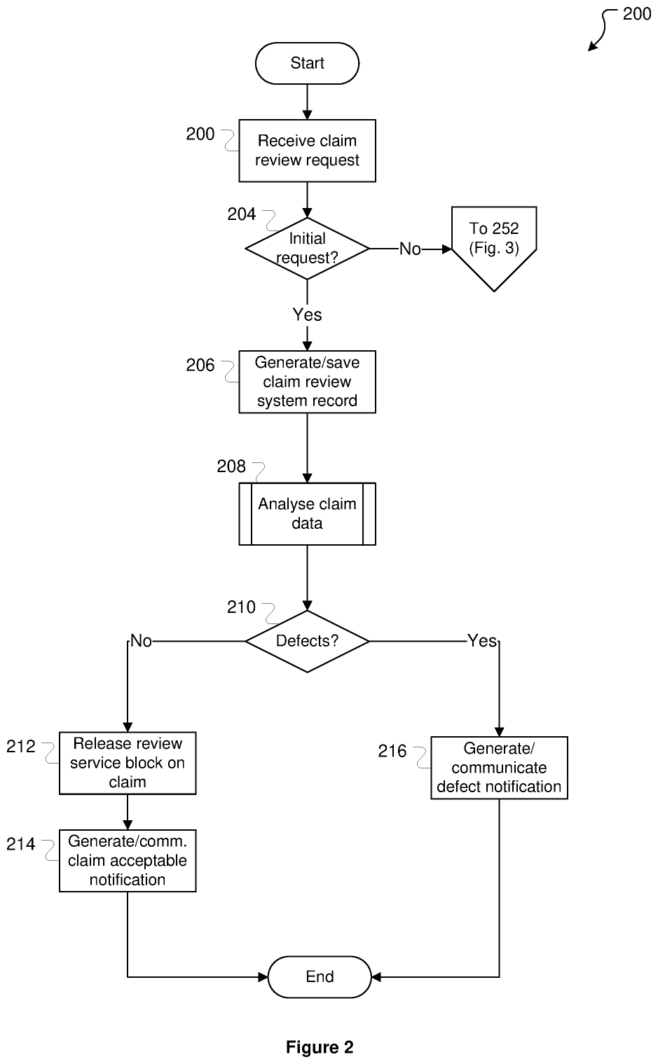

This section describes a claim submission process 200 (FIG. 2) in accordance with an embodiment.

Process 200 may be performed at various points throughout a patient's episode of care, with the output of the process being (generally speaking) an indication that the current state of a submitted claim is acceptable, that there are potential defects (together with comments/suggestions in respect of those potential defects), and/or that there are likely defects (together with comments/suggestions in respect of those likely defects). This output is provided in real (or near-real) time to provide the submitter with guidance on the claim.

For example, a claim may be submitted for review on a patient's admission, in which case the output of the process guides submitters on relevant information that is best captured during face to face discussions with the patient and/or their carer, such as date of birth etc. A claim may also (or alternatively) be submitted for review during a patient's episode of care. In this case, the output of the process provides guidance as to relevant information that is best captured during a patient's episode of care, such as their medication history, current treatments and services delivered etc. A claim may also (or alternatively) be submitted for review at or following a patient's discharge/completion of the patient's episode of care. In this case, the output of the process provides guidance to ensure relevant information that is best captured post discharge of a patient is captured, such as the complete history of treatment performed and services delivered etc.

Overall, the outputs of the claim review process are aimed at helping the submitter (e.g. hospital) reduce revenue leakage, inefficiencies, costs, and waste.

At 202, the claim review system 120 receives a claim review request from a submitter system 110. More specifically, the server application 122 of the claim review system 120 receives a claim review request from the review system client application 112 of a submitter system 110.

The claim review request is associated with claim data. The claim data is typically all data that is available to the submitter at the time of submission and that is related to a particular episode of care for a particular patient.

The claim data is typically received from the submitter system 110 with/at the same time as the request, however may be submitted/uploaded separately. Further, and as discussed below, the claim data pertaining to a given request may be updated over time (e.g. as revised claims are submitted for analysis).

The particular claim data that can be submitted to the claim review system 120, and the format in which it is submitted, will depend on the particular implementation. In certain embodiments, when an operator of the submitter system 110 wishes to prepare/submit a claim for review, the review system client application 112 is configured to automatically extract relevant data from the submitter database system 114 for inclusion in the request. In alternative embodiments, an operator of the submitter system 110 wishing to submit a claim for review is provided with a user interface (e.g. a web page or alternative interface) with input fields for manual entry of the required claim data.

By way of example, Table A below provides an example JSON format for communicating claim data from the submitter system 110 to the claim review system 120:

TABLE A
Example claim data JSON format

```
{
  “messageType”: “0001”,
  “customerID”: “C001”,
  “hospitalName”: “ABC HOSPITAL”,
  “surgeonID”: “ABC00343”,
  “admissionID”: “ABC001234”,
  “admissionDt”: “25-SEP-18”,
  “separationDt”: “30-SEP-17”,
  “lengthOfStayDays”: “5”,
  “yearOfBirth”: “1956”,
  “gender”: “M”,
  “theatreSessionID”: “1823455”,
  “theatreDt”: “25-SEP-18”,
  “theatreTm”: “00:55:00”,
  “drg”: “I01B”,
  “drg_v”: “8”,
  “principalDiagnosis”: “M17.0”,
  “mbs”:
    [
      “49518”
    ],
  “achi”:
    [
      “49518-00”,
      “92514-39”,
      “95550-03”
    ],
  “prosthesis”:
    [
      {“id”: “ BV002”, “count”: “1”},
      {“id”: “ HK008”, “count”: “1”},
      {“id”: “ BV011”, “count”: “1”},
      {“id”: “ BV004”, “count”: “1”}
    ]
}
```

By way of alternative example, claim data may be communicated to the claim review system 120 in a table format such as that shown in Table B below:

TABLE B
Example claim data table format

| Field | Data type | Example data |
|---|---|---|
| Hospital_Name | alphanumeric | ABC Hospital |
| Admission_Number | alphanumeric | ABC001234 |
| Year_of_Birth | YYYY | 1956 |
| Gender | M/F/X | M |
| Surgeon_ID | alphanumeric | ABC00343 |
| Admission_Date | DD-MMM-YY | 25 Sep. 2018 |
| Separation_Date | DD-MMM-YY | 30 Sep. 2018 |
| LOS_Days | decimal | 5 |
| DRG_Code | alphanumeric | I01B |
| DRG_Version | Numeric | 8 |
| Principal_Diagnosis | alphanumeric | M17.0 |
| Theatre_Session | alphanumeric | 1823455 |
| Date_of_Surgery | DD-MMM-YY | 25 Sep. 2018 |
| Surgery_Length_of_Time | HH:MM | 00:55 |
| ACHI_Codes | alphanumeric | 49518-00; |
| | | 92514-39; |
| | | 95550-03 |
| MBS_Item_Numbers | Alphanumeric | 49518 |
| Prosthesis_Codes_with_Quantity | Alphanumeric | BV002:1; HK008:1; |
| | | BV011:1; BV004:1 |

In certain embodiments, the claim review system 120 checks the claim review request when received to ensure that the claim data included therein is compliant with formatting requirements. If the claim review request has errors, the claim review system 120 returns a message to the submitter system 110 (e.g. via the application 112 or other communication channel (e.g. email)) advising of the errors. In this case the claim review system 120 pauses/ceases processing the claim until a revised review request has been received.

At 204, the claim review system 120 determines whether the claim review request received at 202 is an initial request (i.e. the first time data in respect of the particular episode of care has been submitted to the system 120) or a subsequent request (i.e. data in respect of the particular episode of care has previously been submitted, and review for a second/subsequent time is being requested).

The determination at 204 may be made in various ways, but will typically involve extracting an identifier from the submission to determine whether a submission with that identifier has already been received and analysed. The identifier is based on one more claim data items included in the submission. By way of example, and using the claim data of Table A, the identifier may be a combination of the Hospital_Name and Admission_Number data items. As an alternative example, again using the claim data of Table A, the identifier may be a combination of the Hospital_Name, Admission_Number, Theatre_Session, and Date_of_Surgery data items.

If, at 204, the claim review system 120 determines that the claim review request is an initial request, processing proceeds to 206. If the claim review request is determined to be a subsequent request, processing proceeds to 250 (FIG. 3).

At 206, the claim review system 120 has determined the claim review request received at 202 to be an initial request. In this case, the review system 120 extracts claim data from the request to generate a claim review system record in respect of the request. The claim review system 120 saves the claim review system record to the claim database 130.

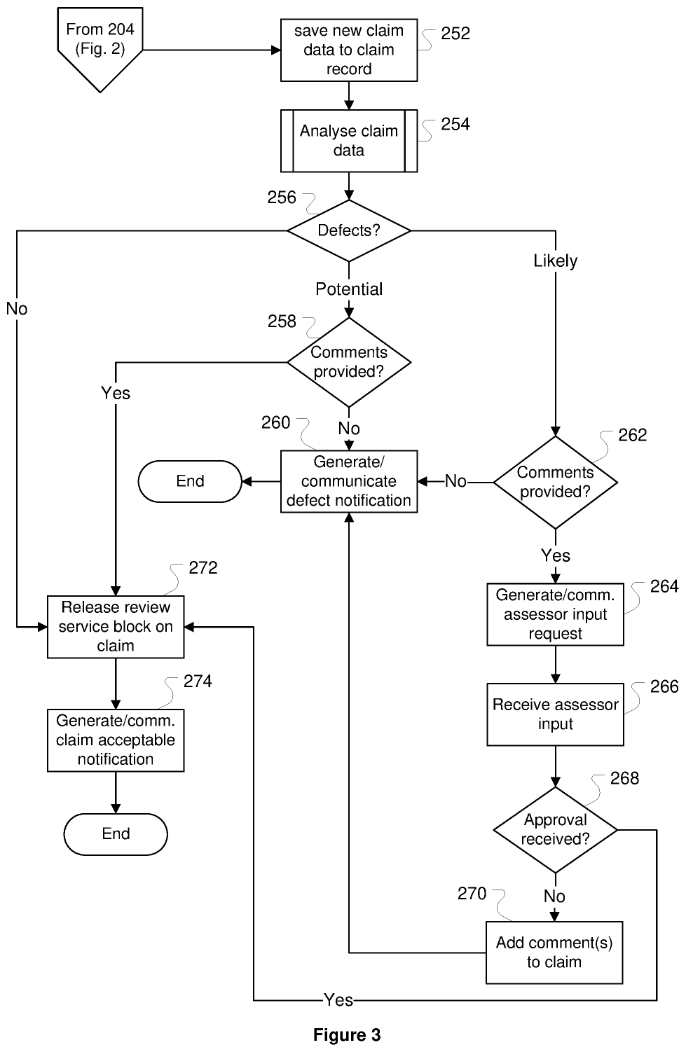

At 208, the claim review system 120 analyses the claim data. Claim analysis is described in further detail below with respect to FIG. 4.

The claim analysis process returns an analysis report. The analysis report includes defect data in respect of any potential or likely defects that have been identified. Where no potential or likely defects are identified, the analysis report will indicate this (e.g. by being empty or explicitly reporting the claim is acceptable). The defect data includes an identifier in respect of the claim in question, whether issues have been detected or not, and where issues have been detected an indication of the issue and/or recommendation in respect thereof. In certain embodiments, defect data further includes one or more rule identifiers indicating the rule(s) that were triggered to result in the identified defects.

A given defect (likely or potential) may be in respect of a feature/item that has been included in the submitted claim data but appears anomalous (i.e. potentially should not be included). A given defect may alternatively be in respect of a feature/item that has been omitted from the submitted claim data (i.e. a feature/item that should potentially be included).

At 210, the claim review system 120 determines whether the claim has potential/likely defects or not (e.g. by processing the analysis report returned from the analysis process at 208). If the claim does not have any defects, processing proceeds to 212. Otherwise, processing proceeds to 216.

In certain embodiments, the submitter system 110 is configured to maintain a block variable in respect of all claims created by the submitter system 110. The block variable may be implemented by a flag or any other variable having one value (e.g. True) indicating the block is in place (which prevents the associated claim from being submitted to an insurer) and another value (e.g. False) indicating that the block is not in place (at which point the associated claim can be submitted to the insurer). In such embodiments, each time a new claim is created the block variable for that claim is set to true (i.e. block in place), and only the claim review system 120 can cause the block variable to be set to false (i.e. to release the block). In such embodiments, if the review system 120 determines that the claim is acceptable, it generates and communicates a block removal message in respect of the claim to the submitter system 110 (using an API endpoint provided by the submitter system 110 for that purpose). When received by the submitter system 110, the block removal message causes the submitter system 110 to change the block variable to the value that allows submission of the claim (i.e. so that the block has been removed).

If no claim block is implemented, step 212 is omitted.

At 214, the review system 120 generates a claim acceptable notification and communicates this to the submitter system 110. This notifies the submitter system 110 that the claim submitted at 202 is acceptable for submission (and, where used, that the claim review block has been removed). Process 200 then ends. Generally speaking, the claim acceptable notification will include identification information allowing the claim in question to be identified and an indication that no issues have been detected/the claim is acceptable.

On receipt of the claim acceptable notification, the claim can be submitted to the insurer per normal channels. This may be an automatic process (i.e. the submitter system 110 is configured to automatically submit the claim on receiving the claim acceptable notification) or manual (i.e. an operator of the submitter system 110 must take further action)

At 216, potential or likely defects have been identified. In this case, the review system 120 generates a defect notification providing suggestions in respect of the one or more defects that have been identified and communicates this to the submitter system 110.

Where the defect notification is communicated directly to the review system client application 112, the submitter system 110 receives the notification and presents a defect interface displaying the defect notification (or information derived therefrom). Via the defect interface an operator of the submitter system 110 can view the defects and associated information, make changes to the claim, and/or provide comments in respect of the defect(s) raised. The operator of the submitter system 110 can then resubmit the claim (as amended and/or with comments if provided) to the claim review system 120.

Generally speaking, the defect notification will include identification information allowing the claim in question to be identified, an indication that defects have been identified, and information relating to those defects (for example a suggested review action such as “Please review if multiple valves were used in this surgery”). In certain embodiments, the information relating to the defects may further include one or more rule identifiers indicating the rule(s) that were triggered that lead to the defect(s).

Table C below provides an example JSON format for communicating claim defect information from the claim review system 120 to the submitter system 110 (or, specifically, to the claim review client application 112 operating thereon):

TABLE A
Example claim data JSON format

```
{
  “messageType”: <message_code>,
  “customerID”: <customer_id>,
  “admissionID”: <admission_id>,
  “addmissionDate”: <admission_date>,
  “theatreSessionID”: <theatre_session_id>,
  “theatreDate”: <threatre_date>,
  “claim_status”: <success/failure/warning>
  // response details are filled if status is failure or warning
  “response_details”:
  [
    {“id”: <response_id>, “description”: <description of
    error/warning>},
    {“id”: <response_id>, “description”: <description of
    error/warning>},
    {“id”: <response_id>, “description”: <description of
    error/warning>},
    {“id”: <response_id>, “description”: <description of
    error/warning>}
  ]
}
```

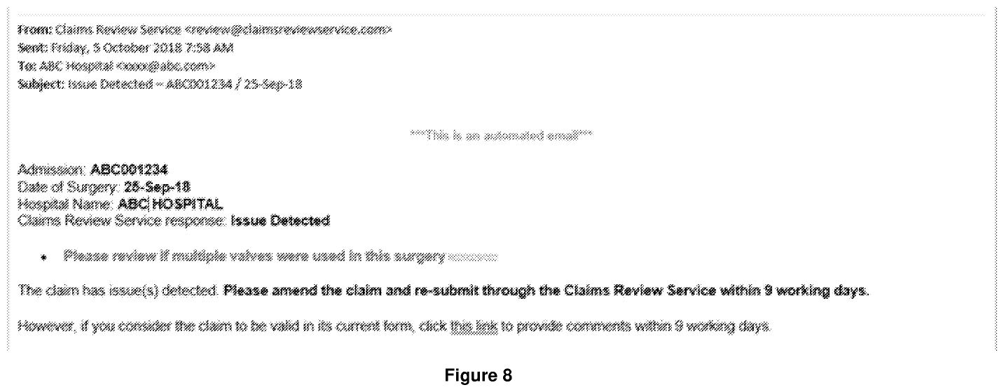

The defect notification in respect of a claim may also (or alternatively) be communicated by email (e.g. emailed to an email address provided by the submitter system 110 associated with the claim review request in question) or an alternative communication channel. FIG. 8 provides an example email format of a defect notification in respect of a claim in which issues have been detected.

Turning to FIG. 3, at 252 the review system 120 has determined the claim review request received at 202 is a subsequent claim review request. In this case the review system 120 extracts claim data from the request and appends/saves it to the claim review system record that already exists for the request (e.g. by writing the new/amended claim data to the claim database 130).

At 254, the claim review system 120 analyses the claim data (described below with respect to FIG. 4).

At 256, the claim review system 120 determines whether the claim has any possible/likely defects or not and, if so, the type of defects (e.g. by processing the analysis report returned from the analysis process at 254). If the claim is determined to have only potential defects, processing proceeds to 258. If the claim is determined to have any likely defects, processing proceeds to 262. If the claim is determined to have no defects, processing proceeds to 272.

At 258, the review system 120 has determined that a subsequent review of a claim has identified only potential defects. In this case the review system 120 determines whether comments in respect of all potential defects identified have been provided. If so, processing proceeds to 272. If not, processing proceeds to 260.

At 260, the review system 120 generates a further defect notification and communicates this to the submitter system 110. The content of the defect notification will depend on the state of the claim (i.e. how 260 is reached).

If 260 is reached as a result of submitter comments not being provided in respect of any potential defects (per 258) or likely defects (per 262, discussed below), the defect notification indicates the defects for which comments have not been provided and includes a direction for these to be added by an operator of the submitter system 110.

If 260 is reached as a result of assessor comments being received and associated with one or more likely defects (per 270, discussed below), the defect notification will include the likely defect(s) to which assessor comments have been added and the assessor comments which are to be reviewed by an operator of the submitter system 110.

In either case, once the review system 120 has generated the defect notification at 260 and communicated this to the submitter system 110, process 200 ends.

At 262, the review system 120 has determined that a subsequent review of a claim has identified likely defects. In this case the review system 120 determines whether comments in respect of all likely defects identified have been provided. If not, processing proceeds to 260 (described above). If comments have been provided for all identified likely defects, processing proceeds to 264.

At 264, the review system 120 generates an assessor input request and communicates this to an assessor system 140.

The assessor input request includes data from the claim in question, the defect(s) identified in the claim, and the comments in respect of those defects as provided by the claim submitter. This information is communicated to the review system client application 142 installed on the assessor system 140, which uses information from the assessor input request to generate an assessor interface. Via the assessor interface an assessor can review the claim/defects/submitter comments and provide assessor input. The assessor input can include, for example, input indicating that the claim should be allowed or (if the assessor does not allow the claim) input providing assessor comments to the claim/likely defects already identified therein.

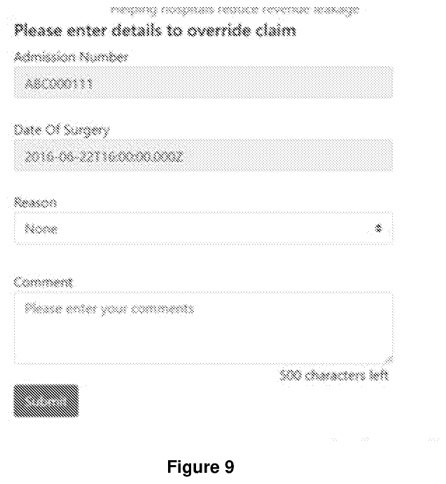

By way of example, FIG. 9 provides an example assessor user interface usable by an assessor to allow a claim and provide reasons/comments for that action.

Once the assessor has reviewed the claim and provided assessor input, he or she activates a submit control or the like on the assessor interface, causing the assessor system 140 to communicate the assessor input back to the claim review system 120.

At 266, the review system 120 receives assessor input from the assessor system 140.

At 268, the review system 120 processes the assessor input to see if the assessor has approved the claim. If so, processing proceeds to 272. If not, processing proceeds to 270.

At 270, the assessor comments received in the assessor input are associated with the claim in question. Processing then proceeds to 260 where the review system 120 generates and communicates a defect notification as described above.

At 272, the claim is determined to be ready for submission to the insurer. This may be because: no defects were identified in the claim (per 256); only potential defects were identified, but submitter comments have been provided in respect of all potential defects (per 258); or likely defects were identified but the claim was approved by an assessor (per 268).

At 272, therefore, the claim review system 120 removes the claim review block on the claim (as per 212 described above) and at 274 generates/communicates a claim acceptable notification (per 214 described above). Process 200 then ends.

### Claim Analysis

Process 200 described above involves the analysis of claims (at 208 and 254). This section describes a claim analysis process in accordance with an embodiment.

In the present invention, claim analysis is performed by analysis engine 124. Analysis engine 124 is a rules engine which uses a plurality of rules to analyse claim data. Configuration and use of the analysis engine 124, therefore, involves two general sets of operations: a rule generation process in which rules are created, and an analysis process whereby the analysis engine 124 is operated to analyse claim data using the rules.

Rules and Rule Generation

In the present embodiment, rules that are generated and used by the claim review system 120 can be categorised into three areas: required rules, logical rules, and correlated rules. Generally speaking, defined rules include a precondition (the existence of one or more data items in the claim) and a postcondition (one or more data items that should also exist if the precondition is met).

Each type of rule is based on the existence (or otherwise) of certain data items in claim data relating to a particular claim (e.g. claim data relating to a patient's episode of care). By way of example, items of claim data may include those maintained by the submitter database system 114 which, as discussed above, may include items such as: hospital data; patient identification data; patient age data; referring doctor data; treating doctor data (and their specialties); clinical condition and/or clinical code data; clinical diagnosis and/or clinical diagnosis code data; past treatment and/or treatment code data; past, current and planned medication and dosage data; proposed treatment and/or treatment code data; actual treatment and/or treatment code data; implants used and/or implant code data; consumables used and/or consumable code data; length of surgical time data; admission date/time data; separation/discharge date/time data; length of stay data; DRG code data; clinical notes data; admission notes data; referral notes data; and or any other data items.

Generally speaking, a required rule defines that if one or more specific data items exist in a given set of claim data (the rule precondition), a related item should also exist in the claim data. If that related item does not exist in the claim data, the rule operates to generate a suggestion—e.g. that inclusion of the missing related item should be considered as part of the patient's episode of care/for inclusion in the claim.

By way of example, a required rule may define that if claim data for a patient includes a data item indicating that a single coronary stent was implanted (e.g. a particular treatment code) then the claim data should also include a data item in respect of the single coronary stent.

As a further example, a required rule may define that if claim data for a patient includes a data item indicating that a ‘reload’ for a laparoscopic stapling device occurred, the claim data should also include a data item in respect of a laparoscopic stapling device.

Generally speaking, a logical rule defines that if the one or more specific data items exist in a given set of claim data (the rule precondition), one or more defined logical actions should have been taken to effectively diagnose, treat or deliver the required services to the patient. Once again, if the logical action defined by the rule does not exist in the claim data, the rule operates to generate a suggestion—e.g. that action should be considered as part of the patient's episode of care/for inclusion in the claim.

By way of example, a logical rule may define that if claim data for a patient includes a data item indicating that a drug was administered to treat a urinary tract infection, then the claim data should also include a data item indicating that a urinary tract infection diagnosis has been performed.

By way of further example, a logical rule may define that if claim data for a patient includes data items indicating a patient had an interocular lens and glaucoma drainage medical device, but only had a glaucoma treatment documented, then a query should be raised to check with the claim submitter whether the patient also had cataract surgery as part of their episode of care.

By way of still further example, a logical rule may define that if claim data for a patient includes data items indicating that a bilateral knee procedure was performed but that the implants used within surgery correlated to a single knee procedure, then a query is to be raised to check with the claim submitter whether a single or bilateral knee procedure was performed on the patient.

Generally speaking, correlated rules are generated by expert clinical or procedural knowledge or using machine learning techniques on historical data held within the system. Correlated rules are used to identify unusual patterns within a set of claim data (e.g. relating to patient's episode of care). Where unusual patterns are identified, a correlated rule results in claim data being flagged for further review and, if appropriate, information being added to the claim data. Where a correlated rule is triggered it too results in a suggestion that a particular action or item should be considered as part of the patient's episode of care/for inclusion in the claim.

By way of example, a correlated rule may operate where claim data indicates that a patient is scheduled to have an infusion of a chemotherapeutic agent and the admission date/time and discharge date/time correlate to historical chemotherapeutic infusions for that patient and other patients, but no chemotherapeutic agent is included in the claim data. In this case, the correlated rule would result in a query being raised for the submitter to review if a chemotherapeutic agent was used during the patient's episode of care.

As a further example, a correlated rule may operate where claim data indicates that a patient only has a total single knee replacement procedure documented within their episode of care but the length of stay correlates to historical lengths of stay where single knee replacement procedures also had pain management and physiotherapy services documented. In this case, the correlated rule would result in a query being raised for the submitter to review if pain management and physiotherapy services were delivered to the patient during their episode of care.

By way of more general example, a correlated rule may a form such as ‘At hospital XXX, and surgeon YYY, and surgery ZZZ, then claim should contain A, B, C, D’. A correlated rule such as this only applies to one hospital and one surgeon in that hospital and one operation that surgeon performs in that hospital.

The rules for use by the analysis engine 124 may be generated in various ways. One example rule creation process 400 will be described with reference to FIG. 4.

At 402, a rule hypothesis is generated or defined. A rule hypothesis is based on a potential relationship between two or more data fields in respect of which data is maintained. Rule hypotheses may be conceived and manually input by a user. Rule hypotheses may also be automatically generated by the rule generation engine 126. Rule hypotheses may be automatically generated based on analysis of available data (e.g. in the claim database 130 and/or learning database 134) using techniques such as market basket analysis or any other appropriate technique.

By way of illustration, example rule hypotheses may be: when an adult male has a single knee procedure, they will have pain management device used as part of their surgery; when an adult male has a bilaterial knee procedure, they will have pain management device used as part of their surgery; when an adult female has a single knee procedure, they do not have a pain management device used in their surgery; when an adult female has a bilateral knee procedure, they do not have a pain management device used in their surgery.

At 404, the rule generation engine 126 tests the rule hypothesis generated at 402 to determine whether there is a sufficiently strong relationship between the data fields identified in the claim hypothesis. Hypothesis testing at 404 may be performed in various ways, for example by statistical methods and/or machine learned techniques. By way of example, and continuing the example hypotheses above, various statistical methods may be employed to assess the strength of the relationship between gender of adult patients and the use of pain management devices in single and bilateral knee procedures.

At 406, the rule generation engine 126 determines whether the data fields identified in the claim hypothesis exhibit a sufficiently strong relationship (e.g. based on correlation, probability, or other forms of relationships between data points). If so, processing proceeds to 408. If not, process 400 ends.

By way of example, and assuming that the relationship between data fields is expressed in numerical terms (e.g. a correlation coefficient): if the relationship is less than a lower threshold, the claim hypothesis is rejected; if the relationship is greater than/equal to the lower threshold but less than an upper threshold the hypothesis is accepted (and the ensuing rule is considered relate to a potential/minor defect); if the relationship is greater than the upper threshold the hypothesis is accepted (and the ensuing rule is considered relate to a likely/major defect). Specific thresholds may be selected as desired, but as a specific example, the lower threshold may be 80% and the upper threshold 90%.

At 408, a draft rule based on the hypothesis is generated. This rule may be generated programmatically or by an assessor reviewing the hypothesis and results.

By way of example, a natural language rule arising from one of the hypotheses above could be along the following lines: IF Male AND>18 years old (i.e. Year of ‘Date of Surgery’−Year of birth=>18) AND single OR bilateral knee surgery, THEN pain management device SHOULD be claimed. In this natural language rule expression, the ‘Should’ indicates that the rule is in respect of a potential/minor defect. If the rule related to a likely/major defect, the suggestion accompanying the rule would be worded more strongly—e.g. “ . . . THEN pain management device MUST be claimed.” (Of course even for a major defect the rule may be proven not to apply—and a claim accepted by an assessor following review notwithstanding the breach of such a rule.)

At 410, the rule generation engine 126 passes the draft rule over a test dataset. In the present example, the test dataset is maintained by the learning database 134.

At 411, an assessor assesses the results of applying the rule to the test dataset to determine if the rule is to be maintained/published or rejected. If the rule is rejected processing ends. If the rule is to be continued with, processing continues to 412.

At 412, the rule generation engine 126 generates a priority score for the draft rule. The priority score may be based on various factors, for example the availability of clinical expertise to validate the applicability of the draft rule, the dollar impact of the draft rule, the anticipated frequency that the draft rule would be invoked, and or other factors. The priority score for a draft rule is used to help prioritise the order in which draft rules are submitted to assessors for their input (e.g. per 414 and 416).

At 414, the rule generation engine 126 communicates the draft rule (and associated data—e.g. the results from passing the draft rule over the test dataset at 410 and priority score information generated at 412) to a rule assessor. This can be performed in various ways. For example, the draft rule (and associated data) may be communicated to the review system client application 142 installed on the assessor system 140. The application 142 generates a rule assessment interface useable by a rule assessor to review the draft rule and associated data and provide input. The input may, for example, be to approve the draft rule, to reject the draft rule, or to modify the draft rule.

At 416, the rule generation engine 126 receives and processes rule assessor input in respect of the draft rule.

If, at 416, the rule assessor input indicates the rule is to be rejected, process 400 ends.

If, at 416, the rule assessor input provides modifications to the rule, the rule generation engine 126 makes these modifications at 418 and then passes the modified rule back to 410 so the modified rule can be passed over the test dataset.

If, at 416, the rule assessor input allows the rule, processing proceeds to 420. In addition to accepting the rule, the assessor also indicates they type of rule—e.g. whether the rule is in respect of a potential defect or a likely defect. As discussed above, in certain embodiments the type of defect a rule relates to (potential or likely defect) is determined based on the tested validity of the rule—e.g. the strength of the relationship as determined by testing the rule at 402.

At 420, the rule generation engine 126 saves the rule (e.g. by adding it to the rule database 132) so it can be applied to incoming claim requests. Process 400 then ends.

Claim Analysis

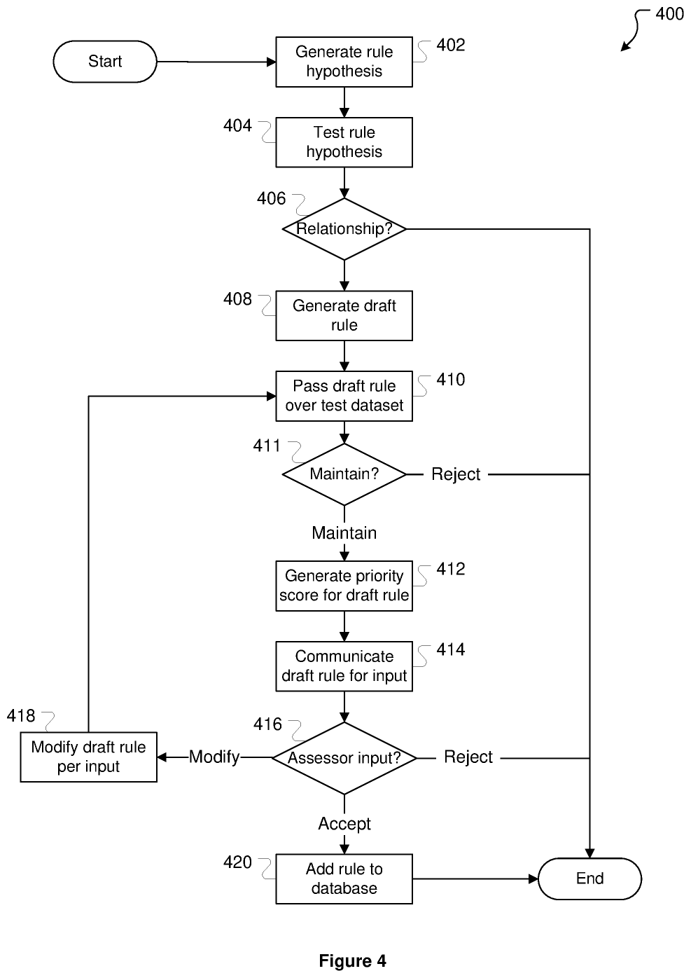

FIG. 5 provides a flowchart indicating operations performed during the analysis of a claim (e.g. at 208 and 254 of process 200).

At 502, the analysis engine 124 receives or accesses claim data. This may be accessed, for example, from the claim database 130.

In certain embodiments, the analysis engine 124 is configured to filter the rules that can potentially be applied to a given claim request. In this case filtering is performed at 503. If no filtering of the rules is performed, processing proceeds from 502 directly to 504.

At 503, where implemented, the analysis engine filters the superset of rules (i.e. all rules in the rule database 132) in accordance with one or more filter criteria. This generates a subset of rules which are considered at 504. Filter criteria may relate to specific rules or specific types of rules and will typically be submitter specific. For example, a particular submitter A may only wish to be advised of likely defects and not potential defects. In this case, when analyzing any claim review request received from submitter A the analysis engine 124 will filter the rules so that the resulting subset includes only rules relating to likely defects.

At 504, the analysis engine 124 processes the applicable rules (e.g. from the rules database 132) to determine whether any rules potentially apply to the claim data. Where filtering is performed at 503, the applicable rules will be the subset of rules resulting from the filtering process. Where filtering is not performed, the applicable rules will be the superset of rules (e.g. all rules in the rule database 132).

Generally speaking, determining rule applicability involves assessing the claim data to determine whether the rule precondition is met. If so, the rule is determined to potentially apply, and if not the rule is determined not to potentially apply. Continuing with the example correlated rule described above (‘At hospital XXX, and surgeon YYY, and surgery ZZZ, then claim should contain A, B, C, D”), determining whether this rule potentially applies involves determining whether the claim in question involves hospital XXX, surgeon YYY and surgery ZZZ (the rule preconditions). If the claim involves all these things, the rule precondition is met and the rule potentially applies. If not the rule does not potentially apply.

If one or more rules are determined to potentially apply, processing proceeds to 506. If no rules potentially apply, the process ends.

At 506, the analysis engine 124 selects the next unprocessed rule that has been determined to potentially apply to the claim data.

At 508, the analysis engine 124 tests the rule selected at 506 against the claim data. Generally speaking, this involves analyzing the claim data to determine if the postcondition associated with the rule exists in the claim or not. If the post condition does exist, the rule does not apply. If the post condition does not exist the rule does apply.

Continuing again with the example correlated rule described above (‘At hospital XXX, and surgeon YYY, and surgery ZZZ, then claim should contain A, B, C, D”), determining whether this rule applies involves determining whether the claim in question contains all of A, B, C, and D (i.e. that the rule post condition exists). If the claim already includes all of A, B, C, and D the rule does not apply (there is no need to suggest/require the addition of A, B, C, and D as they are already included in the claim). Alternatively, if any of A, B, C, or D aren't in the claim, the rule does apply (in which case one or more of A, B, C, and D needs to be suggested for inclusion in the claim).

Applying a rule to the claim data generates a rule application result. The rule application result either indicates that the rule does not apply or that that the rule does apply. Where the application result indicates that the rule does apply it further includes the suggestion that flows from the rule applying—i.e. that one or more items should/must (depending on whether the rule relates to a potential/minor defect or likely/major defect) be considered for inclusion in the claim.

At 510, the analysis engine 124 determines (from the rule application result) whether the current rule applies to the claim data or not. If so, processing proceeds to 512. If not, processing proceeds to 514.

At 512, the analysis engine 124 has determined that the current rule does apply to the claim data. In this case the analysis engine 124 appends the rule application result (or information derived therefrom) to an analysis report. Continuing with the above example, where a rule is determined to apply the suggestion associated with that rule (e.g. a suggestion that one or more particular actions or items should be considered as part of the patient's episode of care/for inclusion in the claim) is appended to the analysis report. Processing then continues to 514.

At 514, the analysis engine determines whether there are any rules that potentially apply to the claim data (as identified at 504) that have not yet been tested. If so, processing returns to 506 where the next unprocessed rule is selected for testing.

If, at 514, all potentially applicable rules have been tested, processing proceeds to 516. At 516, the analysis engine 124 returns the analysis report and processing ends.

Example Review System Architecture

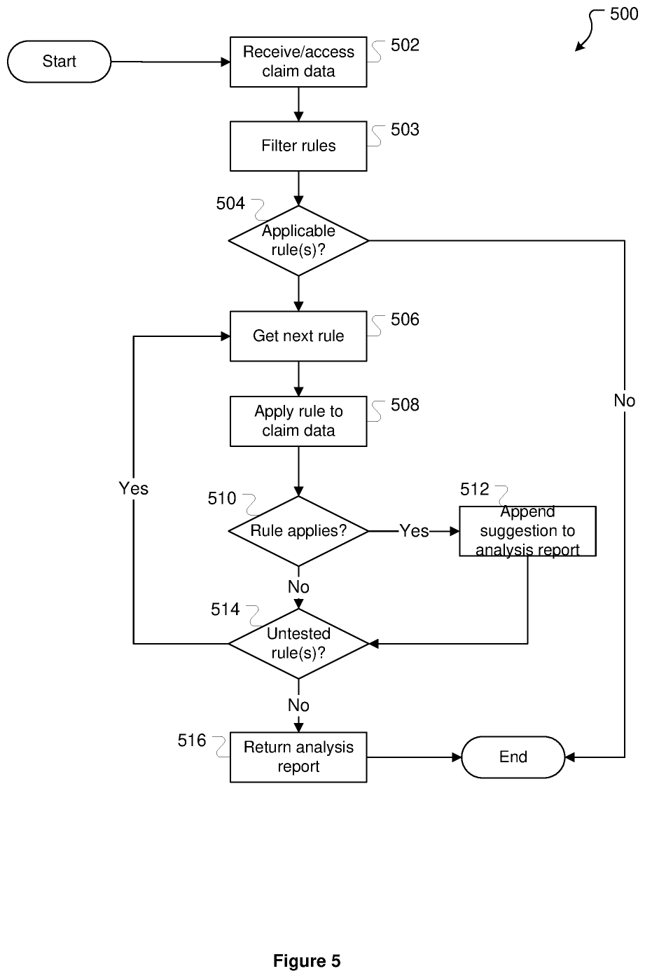

In certain embodiments, the claim review system 120 is a cloud hosted system that provides claim review as a service. FIG. 6 provides an example review system 120 with a microservices architecture for cloud implementation. The microservices architecture will be described using the Amazon Web Services (AWS) platform as the specific cloud provider. Alternative cloud providers or on-premise hosting may, however, be used. Furthermore, different implementations may make use of alternative architectures—e.g. architectures with additional, fewer, or alternative services.

Architecture 600 includes a load balancing service for routing incoming review requests between claim upload servers 604. In the AWS context, Amazon's elastic load balancing (ELB) service is configured to provide the load balancing service and mapping the external request to the internal termination that provides an extra layer of security.

Architecture 600 includes one or more claim upload server(s) 604 to which review system client applications 112 can connect to upload claims for review. In the AWS context, the claim upload server(s) 604 is/are provided by the an elastic compute cloud (EC2) service which allows for server capacity to be scaled based on demand—i.e. by deploying/removing virtual servers on an as needs basis. The claim upload servers(s) 604, however can be replaced by serverless services (e.g. AWS Lambda) in future.

Architecture 600 includes a storage service 606 for storing data in respect of claims received from review system client applications 112 In the AWS context, the storage service 606 is provided by the Amazon simple storage service (S3).

Architecture 600 includes a Managed API Connectivity 608 for maintaining the API used by the claim upload server(s) 604 to communicate with review system client applications 112. In the AWS context, the Managed API Connectivity 608 is provided by AWS API Gateway service.

Architecture 600 includes a Health System monitoring service 610 for monitoring the various components of the claim review system 120. In the AWS context, the monitoring service 610 is provided by Amazon CloudWatch.

Architecture 600 includes one or more claim routing server(s) 612 which hosts a controller for routing claims. In the AWS context, the claim routing server(s) 612 is/are provided by an EC2 service. In alternative embodiments, the claim routing server(s) 612, may be replaced by serverless services (e.g. AWL Lambda).

Architecture 600 includes a mail server 614 for emailing claim review results to the relevant submitter. In the AWS context, email service may be provided by the Amazon Simple Email Service (SES).

Architecture 600 includes an analysis engine 616 (e.g. a rules engine) for analyzing claims. In the AWS context, the analysis engine is provided by an EC2 service.

Architecture 600 includes a claim results database 618 for storing the data and results of claim analyses performed by the claim analysis server(s). In the present example, the claim results database 618 is a relational database provided by the Amazon Relational Database Service (RDS).

Architecture 600 includes a reporting service 620 providing various reporting functionality with respect to the claim results database 618. By way of example, the reporting service 620 may be provided using Tableau or a similar product.

In addition to the above services, a security service 622 is also provided. By way of example, the security service 622 may be implemented using Cloudflare or a similar product.

In the example microservices architecture described above, the flow for a submitter submitting a claim to the review system 120 is as follows:
1. The submitter submits a claim.
2. A request containing the API Key and the JSON message is sent to the review system 120.
3. The request is received by the API Gateway which authenticates the API key
4. If authenticated, the request is forwarded into the review system application server
5. The review system application server checks for expired values and validity of hospitals based on the date of surgery
   a. If any fields are invalid (for example because codes in the claim are not within their valid date ranges), a response is communicated to the submitter to inform them of this and the process is completed
   b. Otherwise, the request will continue to pass through CRS
6. The application server forwards the request to the analysis engine 618.
7. The analysis engine validates the request against all applicable rules.
8. The response from the Rule Engine is sent back to the application server.
9. The application server returns the response to the email server which will send the final results to the submitter email address and/or to the submitter system (e.g. the client application running thereon).

Hardware Overview

The present invention is necessarily implemented using one or more computer processing systems. Specifically, each of the submitter system 110, the claim review system 120, and the assessor system 140 is a computer processing system (or several computer processing systems working together).

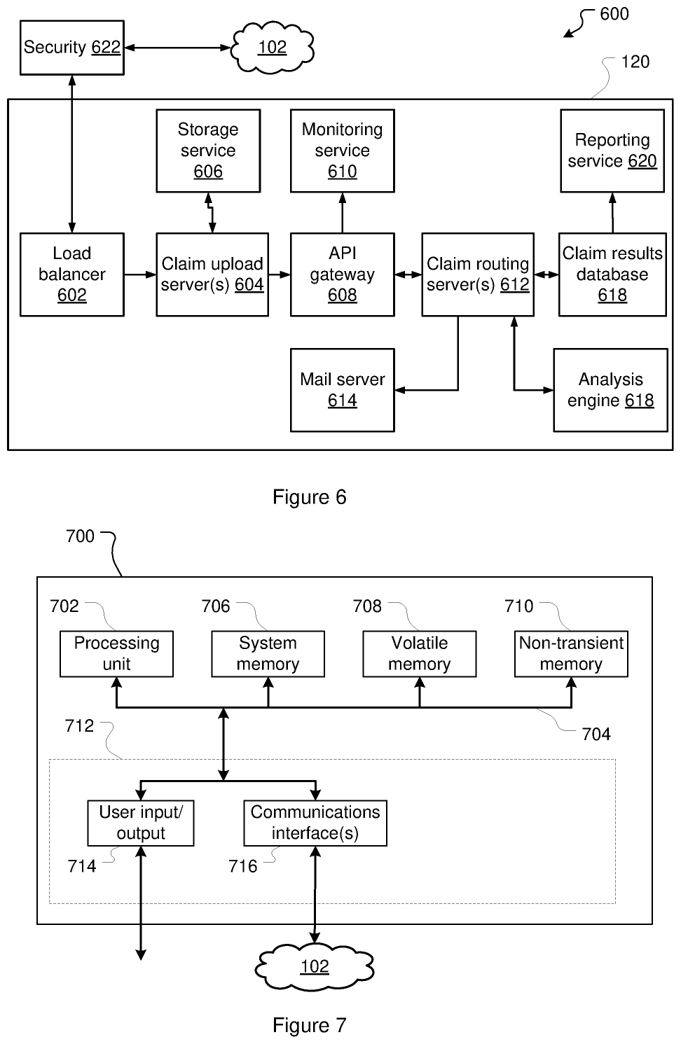

FIG. 7 provides a block diagram of one example of a computer processing system 700. System 700 as illustrated in FIG. 7 is a general-purpose computer processing system. It will be appreciated that FIG. 7 does not illustrate all functional or physical components of a computer processing system. For example, no power supply or power supply interface has been depicted, however system 700 will either carry a power supply or be configured for connection to a power supply (or both). It will also be appreciated that the particular type of computer processing system will determine the appropriate hardware and architecture, and alternative computer processing systems suitable for implementing aspects of the invention may have additional, alternative, or fewer components than those depicted, combine two or more components, and/or have a different configuration or arrangement of components.

Computer processing system 700 includes at least one processing unit 702. The processing unit 702 may be a single computer-processing device (e.g. a central processing unit, graphics processing unit, or other computational device), or may include a plurality of computer processing devices. In some instances all processing will be performed by processing unit 702, however in other instances processing may also, or alternatively, be performed by remote processing devices accessible and useable (either in a shared or dedicated manner) by the system 700.

Through a communications bus 704 the processing unit 702 is in data communication with a one or more machine-readable storage (memory) devices that store instructions and/or data for controlling operation of the processing system 700. In this instance system 700 includes a system memory 706 (e.g. a BIOS), volatile memory 708 (e.g. random access memory such as one or more DRAM modules), and non-volatile memory 710 (e.g. one or more hard disk or solid state drives).

System 700 also includes one or more interfaces, indicated generally by 712, via which system 700 interfaces with various devices and/or networks. Generally speaking, other devices may be physically integrated with system 700, or may be physically separate. Where a device is physically separate from system 700, connection between the device and system 700 may be via wired or wireless hardware and communication protocols, and may be a direct or an indirect (e.g. networked) connection.

Wired connection with other devices/networks may be by any appropriate standard or proprietary hardware and connectivity protocols. For example, system 700 may be configured for wired connection with other devices/communications networks by one or more of: USB; FireWire; eSATA; Thunderbolt; Ethernet; OS/2; Parallel; Serial; HDMI; DVI; VGA; SCSI; AudioPort. Other wired connections are, of course, possible.

Wireless connection with other devices/networks may similarly be by any appropriate standard or proprietary hardware and communications protocols. For example, system 700 may be configured for wireless connection with other devices/communications networks using one or more of: infrared; Bluetooth; Wi-Fi; near field communications (NFC); Global System for Mobile Communications (GSM), Enhanced Data GSM Environment (EDGE), long term evolution (LTE), wideband code division multiple access (W-CDMA), code division multiple access (CDMA). Other wireless connections are, of course, possible.

Generally speaking, the devices to which system 700 connects—whether by wired or wireless means—allow data to be input into/received by system 700 for processing by the processing unit 702, and data to be output by system 700. Example devices are described below, however it will be appreciated that not all computer-processing systems will include all mentioned devices, and that additional and alternative devices to those mentioned may well be used.

For example, system 700 may include or connect to one or more input devices by which information/data is input into (received by) system 700. Such input devices may include physical buttons, alphanumeric input devices (e.g. keyboards), pointing devices (e.g. mice, track pads and the like), touchscreens, touchscreen displays, microphones, accelerometers, proximity sensors, GPS devices and the like. System 700 may also include or connect to one or more output devices controlled by system 700 to output information. Such output devices may include devices such as indicators (e.g. LED, LCD or other lights), displays (e.g. CRT displays, LCD displays, LED displays, plasma displays, touch screen displays), audio output devices such as speakers, vibration modules, and other output devices. System 700 may also include or connect to devices which may act as both input and output devices, for example memory devices (hard drives, solid state drives, disk drives, compact flash cards, SD cards and the like) which system 700 can read data from and/or write data to, and touch-screen displays which can both display (output) data and receive touch signals (input).

System 700 may also connect to communications networks (e.g. the Internet, a local area network, a wide area network, a personal hotspot etc.) to communicate data to and receive data from networked devices, which may themselves be other computer processing systems.

It will be appreciated that system 700 may be any suitable computer processing system such as, by way of non-limiting example, a desktop computer, a laptop computer, a netbook computer, tablet computer, a smart phone, a Personal Digital Assistant (PDA), a cellular telephone, a web appliance. Typically, system 700 will include at least user input and output devices 714 and (if the system is to be networked) a communications interface 716 for communication with a network 102. The number and specific types of devices which system 700 includes or connects to will depend on the particular type of system 700. For example, if system 700 is a desktop computer it will typically connect to physically separate devices such as (at least) a keyboard, a pointing device (e.g. mouse), a display device (e.g. a LCD display). Alternatively, if system 700 is a laptop computer it will typically include (in a physically integrated manner) a keyboard, pointing device, a display device, and an audio output device. Further alternatively, if system 700 is a tablet device or smartphone, it will typically include (in a physically integrated manner) a touchscreen display (providing both input means and display output means), an audio output device, and one or more physical buttons.

System 700 stores or has access to software (e.g. computer readable instructions and data) which, when processed by the processing unit 702, configure system 700 to receive, process, and output data. Such instructions and data will typically include an operating system such as Microsoft Windows®, Apple OSX, Apple IOS, Android, Unix, or Linux.

System 700 also stores or has access to software which, when processed by the processing unit 702, configure system 700 to perform various computer-implemented processes/methods in accordance with the embodiments described herein. Examples of such software include the review system client applications 112 and 142 installed on the submitter and assessor systems 110 and 140 respectively. In the example described above, each service of review system is also implemented by software. It will be appreciated that in some cases part or all of a given computer-implemented method will be performed by system 700 itself, while in other cases processing may be performed by other devices in data communication with system 700.

Instructions and data are stored on a non-transient machine-readable medium accessible to system 700. For example, instructions and data may be stored on non-transient memory 710. Instructions may be transmitted to/received by system 700 via a data signal in a transmission channel enabled (for example) by a wired or wireless network connection.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

As used herein the terms “include” and “comprise” (and variations of those terms, such as “including”, “includes”, “comprising”, “comprises”, “comprised” and the like) are intended to be inclusive and are not intended to exclude further features, components, integers or steps.

Various features of the disclosure have been described using flowcharts. The functionality/processing of a given flowchart step could potentially be performed in various different ways and by various different systems or system modules. Furthermore, a given flowchart step could be divided into multiple steps and/or multiple flowchart steps could be combined into a single step. Furthermore, the order of the steps can be changed without departing from the scope of the present disclosure.

It will be understood that the embodiments disclosed and defined in this specification extends to all alternative combinations of two or more of the individual features mentioned or evident from the text or drawings. All of these different combinations constitute various alternative aspects of the embodiments.

1. A computer implemented method comprising:
receiving, from a submitter system, a claim review request, the claim review request comprising claim data associated with a claim;
determining whether one or more defects exist in the claim based on the claim data; and
in response to determining that no defects exist in the claim data, communicating a claim release message to the submitter system, the claim release message causing a claim block maintained on the claim by the submitter system to be released.

2. The computer implemented method according to claim 1, further comprising:
receiving, from the submitter system, a second claim review request, the second claim review request comprising second claim data associated with a second claim;
determining that at least one defect exists in the second claim;
generating a defect notification comprising information associated with the at least one defect in the second claim and at least one suggested review action; and
communicating the defect notification to the submitter or submitter system.

3. The computer implemented method according to claim 2, further comprising:
receiving, from the submitter system, a further claim review request associated with the second claim, the further claim review request comprising further claim data associated with the second claim, the further claim data comprising one or more of: additional claim data, amended claim data, or comments; and
analyzing at least the further claim data to determine whether any defects exist in the second claim.

4. The computer implemented method according to claim 3, wherein in response to determining that no defects exist in the second claim based on the further claim data, the method further comprises:
communicating a claim release message to the submitter system, the claim release message causing a claim block maintained on the second claim by the submitter system to be released.

5. The computer implemented method according to claim 3, wherein in response to determining that at least one defect exists in the second claim based on the further claim data, the method further comprises:
determining that the at least one defect is minor;
determining that comments associated with the at least one defect have been received from the submitter system; and
in response to determining that the comments associated with the at least one defect have been received from the submitter system, communicating a claim release message to the submitter system, the claim release message causing a claim block maintained on the second claim by the submitter system to be released.

6. The computer implemented method according to claim 3, wherein in response to determining that at least one defect exists in the second claim based on the further claim data, the method further comprises:
determining whether comments associated with the at least one defect have been received from the submitter system; and
in response to determining that comments associated with the at least one defect have not been received from the submitter system:
generating a further defect notification comprising information associated with the at least one defect and, in respect of each defect, a suggested review action; and
communicating the further defect notification to the submitter system.

7. The computer implemented method according to claim 3, wherein in response to determining that at least one defect exists in the second claim based on the further claim data, the method further comprises:
determining whether at least one defect comprises at least one major defect;
in response to determining that the at least one defect comprises at least one major defect, determining whether comments associated with the at least one major defect have been received from the submitter system; and
in response to determining that comments associated with the at least one major defect have been received from the submitter system:
generating an assessor input request; and
communicating the assessor input request to an assessor system.

8. The computer implemented method according to claim 7, further comprising:
receiving, from the assessor system, assessor input;
determining whether the assessor input indicates that the second claim should be allowed; and
in response to determining that the assessor input indicates that the second claim should be allowed, communicating a claim release message to the submitter system, the claim release message causing a claim block maintained on the second claim by the submitter system to be released.

9. The computer implemented method of claim 1, wherein determining whether at least one defect exist in the claim comprises:
determining one or more rules that are potentially applicable to the claim data; and
for each rule determined to be potentially applicable to the claim data:
applying the rule to the claim data to determine whether the rule is applicable;
if the rule is applicable, appending information associated with the rule to an analysis report; and
returning the analysis report.

10. A claim review system comprising:
a processor configured to:
receive a claim review request that comprises claim data associated with a claim;
determine whether one or more defects exist in the claim based on the claim data; and
in response to determining that no defects exist in the claim data, communicate a claim release message, the claim release message being configured to cause a claim block maintained on the claim to be released.

11. (canceled)

12. The claim review system of claim 10, wherein the processor is further configured to:
receive a second claim review request, the second claim review request comprising second claim data associated with a second claim;
determine that at least one defect exists in the second claim;
generate a defect notification comprising information associated with the at least one defect in the second claim and at least one suggested review action; and
communicate the defect notification.

13. The claim review system of claim 12, wherein the processor is further configured to:
receive a further claim review request associated with the second claim, the further claim review request comprising further claim data associated with the second claim, the further claim data comprising one or more of: additional claim data, amended claim data, or comments; and
analyze at least the further claim data to determine whether any defects exist in the second claim.

14. The claim review system of claim 13, wherein the processor is further configured to:
in response to determining that no defects exist in the second claim based on the further claim data, communicate a claim release message to the submitter system, the claim release message being configured to cause a claim block maintained on the second claim by the submitter system to be released.

15. The claim review system of claim 13, wherein the processor is further configured to:
in response to determining that at least one defect exists in the second claim based on the further claim data, determining that the at least one defect is minor;
determining that submitter comments associated with the at least one defect have been received; and
in response to determining that the submitter comments associated with the at least one defect have been received from the submitter system, communicate a claim release message to the submitter system, the claim release message being configured to cause a claim block maintained on the second claim to be released.

16. The claim review system of claim 13, wherein the processor is further configured to:
in response to determining that at least one defect exists in the second claim based on the further claim data, determining whether submitter comments associated with the at least one defect have been received; and
in response to determining that submitter comments associated with the at least one defect have not been received from the submitter system:
generate a further defect notification comprising information associated with the at least one defect and, in respect of each defect, a suggested review action; and
communicate the further defect notification to the submitter system.

17. The claim review system of claim 10, wherein determining whether at least one defect exist in the claim comprises:
determining one or more rules that are potentially applicable to the claim data; and
for each rule determined to be potentially applicable to the claim data:
applying the rule to the claim data to determine whether the rule is applicable;
if the rule is applicable, appending information associated with the rule to an analysis report; and
returning the analysis report.

18. A non-transitory computer-readable storage medium storing sequences of instructions, which when executed by a computer processor, cause the processor to:
receive a claim review request that comprises claim data associated with a claim;
determine whether one or more defects exist in the claim based on the claim data; and
in response to determining that no defects exist in the claim data, communicate a claim release message, the claim release message being configured to cause a claim block maintained on the claim by the submitter system to be released.

19. The non-transitory computer-readable storage medium of claim 18, further comprising instructions, which when executed by a computer processor, cause the processor to:
receive, from the submitter system, a second claim review request, the second claim review request comprising second claim data associated with a second claim;
determine whether at least one defect exists in the second claim;
generate a defect notification comprising information associated with the at least one defect in the second claim and at least one suggested review action;
receive a further claim review request associated with the second claim, the further claim review request comprising further claim data associated with the second claim; and
determine whether any defects exist in the second claim based on the further claim data associated with the second claim; and
in response to determining that at least one defect exists in the second claim based on the further claim data:
determine whether the at least one defect comprises at least one major defect;
in response to determining that the at least one defect comprises at least one major defect, determine whether comments associated with the at least one major defect have been received from the submitter system; and
in response to determining that comments associated with the at least one major defect have been received:
generate an assessor input request; and
communicate the assessor input request to an assessor system.

20. The non-transitory computer-readable storage medium of claim 19, further comprising instructions, which when executed by a computer processor, cause the processor to:
receive, from the assessor system, assessor input;
determine whether the assessor input indicates that the second claim should be allowed; and
in response to determining that the assessor input indicates that the second claim should be allowed, communicate claim release message, the claim release message being configured to cause a claim block maintained on the second claim to be released.

21. The non-transitory computer-readable storage medium of claim 18, further comprising instructions, which when executed by a computer processor, cause the processor to:
identify one or more rules that are potentially applicable to the claim data; and
for each rule identified to be potentially applicable to the claim data:
apply the rule to the claim data to determine whether the rule is applicable;
if the rule is determined to be applicable, append information associated with the rule to an analysis report; and
send the analysis report.
